(19) United States
(12) Patent Application Publication
(10) Pub. No.: US 2021/0244001 A1
(43) Pub. Date: Aug. 12, 2021

(54) LEASH SYSTEMS AND METHODS FOR FASTENING LEASH SYSTEMS

(71) Applicant: NH Solutions, LLC, Vienna, VA (US)

(72) Inventor: Nathan PARK, Vienna, VA (US)

(73) Assignee: NH Solutions, LLC.

(21) Appl. No.: 16/783,374

(22) Filed: Feb. 6, 2020

(51) Int. Cl. A01K 27/00

(52) U.S. Cl. CPC A01K 27/005; A01K 27/001; A01K 27/003

(57) ABSTRACT

A leash system and methods for fastening a leash system for guiding an animal are provided. The leash system may include a collar having a first ring positioned towards an anterior portion of a torso of the animal, a leash strap having a first end, a second end, and a middle portion, the leash strap including a first clasp positioned at the first end of the leash strap for connecting to the first ring; and a second clasp positioned at the second end of the leash strap for connecting to the first ring, the leash strap extends around the torso, wrapping underneath a first leg of the animal, around the back of the animal, and underneath a second leg of the animal, and a leash extension having a second ring for receiving the middle portion of the leash strap between the first clasp and the second clasp.

### TECHNICAL FIELD

The present disclosure generally relates to leash systems and methods for fastening leash systems to animals. More particularly, and without limitation, the disclosed embodiments relate to leash systems for guiding animals.

### BACKGROUND

Current leash systems for handling animals such as household pets include collars and/or harnesses. Collars are devices that attach around a neck of an animal, enabling control or identification by a user. However, using leashes directly attached to collars has a number of downsides. For example, many collars create unwanted forces around the neck of an animal. For example, when a user pulls on a standard leash that is connected to a collar, the pulling force pulls on the collar, pulling on the animal's throat or neck. Similarly, when the animal moves away from a user holding on to the leash and begins to pull the user, the tension in the leash creates a similar pulling force around the animal's throat or neck. These pulling forces around the throat or neck of the animal are detrimental to the animal's health and may cause injury. In turn this means handling the animal is difficult without potentially harming the animal.

Harnesses may be used to mitigate the pulling forces around the neck or throat of an animal; however, harnesses also suffer from several problems. For example, many harnesses are difficult to secure onto an animal. Harnesses may be time-consuming and difficult to secure onto some animals, such as larger or stronger animals. Harnesses can also create weight distribution issues such the animal is able to more easily handle a larger load and effectively ignore a user's pulling force on the leash. This weight distribution may make handling the animal more difficult for a user, particularly when attempting to handle a larger or stronger animal. Additionally, the harnesses offer less in terms of controlling an animal's behavior, such as discouraging pulling. Some harnesses may wrap around an animal's snout, such as a muzzle, which may be uncomfortable for the animal and create other harmful effects. For example, these types of harnesses can make it more difficult for an animal to pant or breathe, cool off, and/or create anxiety or stress in the animal. These types of harnesses may also generate unwanted forces around the nose, neck or throat of the animal, causing injury.

The present disclosure addresses the technical problems with the prior art devices by providing a novel leash system for guiding animals, as provided by the embodiments described herein and characterized in the claims.

### SUMMARY

The embodiments of the present disclosure include leash systems and methods of fastening leash systems around animals. The exemplary embodiments allow for controlled guidance of animals without creating unwanted forces on an animal's neck or throat region.

One embodiment of the present disclosure is directed to a leash system for guiding an animal. The leash system includes a collar for placement around a neck region of the animal, the collar having a first ring positioned towards an anterior portion of a torso of the animal. The leash system further includes a leash strap having a first end, a second end, and a middle portion, the leash strap including a first clasp positioned at the first end of the leash strap, the first clasp for connecting to the first ring; and a second clasp positioned at the second end of the leash strap, the second clasp for connecting to the first ring, wherein the leash strap extends around the torso, wrapping underneath a first leg of the animal, around the back of the animal, and underneath a second leg of the animal. The leash system further includes a leash extension having a second ring for receiving the middle portion of the leash strap between the first clasp and the second clasp.

Another embodiment of the present disclosure is directed to a method of fastening a leash system to an animal. The method comprises positioning a collar having a first ring around a neck region of the animal such that the first ring is positioned towards an anterior portion of a torso of the animal; connecting a first clasp, positioned at a first end of a leash strap, to the first ring; extending the leash strap around the torso; wrapping the leash strap underneath a first leg of the animal; wrapping the leash strap around the back of the animal; wrapping the leash strap underneath a second leg of the animal; and connecting a second clasp, positioned at a second end of the leash strap, to the first ring.

A further embodiment of the present disclosure is directed to leash system for guiding an animal. The leash system includes a leash strap having a first end, a second end, and a middle portion. The leash strap includes a first clasp positioned at the first end of the leash strap, the first clasp for connecting to a first ring of a collar placed around a neck region of the animal, wherein the first ring is positioned towards an anterior portion of a torso of the animal. The leash strap further includes a second clasp positioned at the second end of the leash strap, the second clasp for connecting to the first ring, wherein the leash strap extends around the torso, wrapping underneath a first leg of the animal, around the back of the animal, and underneath a second leg of the animal. The leash strap further includes a second ring positioned at the middle portion of the leash strap between the first clasp and the second clasp, the second ring configured to connect to a leash extension.

Additional features and advantages of the disclosed embodiments will be set forth in part in the description that follows, and in part will be obvious from the description, or may be learned by practice of the disclosed embodiments. The features and advantages of the disclosed embodiments will be realized and attained by the elements and combinations particularly pointed out in the appended claims.

It is to be understood that both the foregoing general description and the following detailed description are examples and explanatory only and are not restrictive of the disclosed embodiments as claimed.

The accompanying drawings constitute a part of this specification. The drawings illustrate several embodiments of the present disclosure and, together with the description, serve to explain the principles of the disclosed embodiments as set forth in the accompanying claims.

### BRIEF DESCRIPTION OF THE DRAWINGS

FIG. 1 is an elevational view of an exemplary leash system, according to embodiments of the present disclosure.

FIG. 2 is a front perspective view of the leash system of FIG. 1 connected to an animal.

FIG. 3 is an elevational view of another exemplary leash system, according to embodiments of the present disclosure.

FIG. 4 is a diagram of an exemplary method of fastening a leash system, according to embodiments of the present disclosure.

### DETAILED DESCRIPTION

Reference will now be made in detail to embodiments and aspects of the present disclosure, examples of which are illustrated in the accompanying drawings. Where possible, the same reference numbers will be used throughout the drawings to refer to the same or like parts.

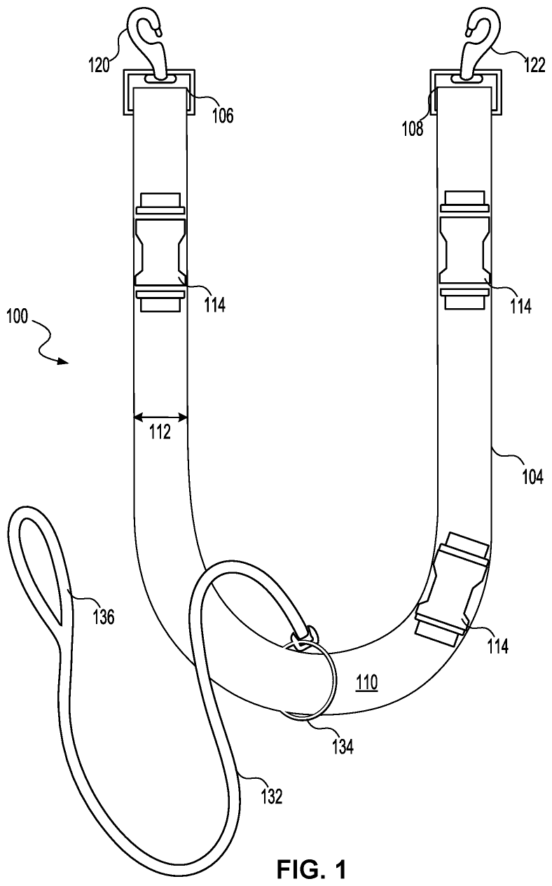

FIG. 1 illustrates an exemplary leash system 100 in accordance with embodiments of the present disclosure. Leash system 100 may include a leash strap 104 having a first end 106, a second end 108, and a middle portion 110. The leash strap 104 may include a durable synthetic webbing that may incorporate a variety of materials including, but not limited to, polypropylene, nylon, polyester, cotton, among others. The leash strap 104 may be designed to withstand forces exerted by an animal, such as a dog or other household pet, of various sizes including small and large animals. In some embodiments, the leash strap 104 may have a width 112 and a thickness (not shown). The width 112 and the thickness of the leash strap 104 may vary depending on the size of the animal the leash strap 104 will be fastened around. For example, the leash strap 104 may have a larger width 112 and a larger thickness for a larger animal to increase the strength of the leash strap 104.

The leash strap 104 may also include at least one length-adjustment clip 114 positioned on the leash strap 104. The at least one length-adjustment clip 114 provides adjustment of the leash strap length. The at least one length-adjustment clip 114 may be a clip, a buckle, a fastener, a snap, a tie, a belt connection, or any other suitable length-adjustment connector. As illustrated, the length-adjustment clips 114 are snap buckles connected to the leash strap 104. The length-adjustment clips 114 may be positioned at various locations on the leash strap 104.

FIG. 1 shows length-adjustment clips 114 positioned near the first end 106, the second end 108 and the middle portion 110 of the leash strap 104. The adjustment clips 114 may each individually adjust the length of the leash strap 104 in the length around each adjustment clip. For example, the adjustment clip 114 positioned near the first end 106 may adjust the length of the leash strap 104 at the first end 106 of the leash strap 104. The adjustment clip 114 positioned near the second end 108 may adjust the length of the leash strap 104 at the second end 108 of the leash strap 104. These adjustments may be desirable during a first use of the leash strap with an animal where the leash strap may not have the appropriate original length to fit the animal. A user may adjust the length of the leash strap 104 using the one or more adjustment clips 114 to adjust the length at different positions around the animal, which provides the user flexibility and improves the fit of the leash strap 104 around the animal.

The leash strap 104 may include a first clasp 120 positioned at the first end 106 of the leash strap 104 and a second clasp 122 positioned at the second end 108 of the leash strap 104. Non-limiting examples of the first clasp 120 and second clasp 122 include, but are not limited to, trigger snap hooks, swivel snap hooks, lobster clasps, carabiner clasps, among others. The first clasp 120 and the second clasp 122 may be connected to a first ring 126 on a collar 130, as will be described below.

The leash system 100 may further include a leash extension 132 that connects to a second ring 134. The second ring 134 may receive and connect to the middle portion 110 of the leash strap 104 between the first clasp 120 and the second clasp 122. The leash extension 132 may extend away from the leash strap 104 and terminate in a handle 136 that a user may hold when handling an animal.

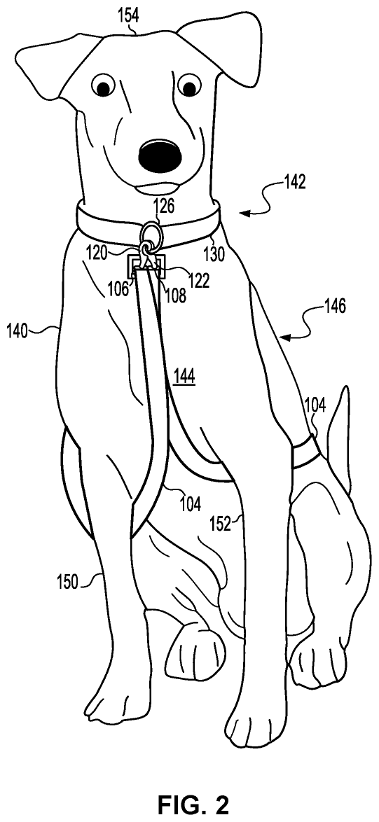

FIG. 2 illustrates the leash system 100 fastened around an animal 140 in accordance with embodiments of the present disclosure. The collar 130 may be placed around a neck region 142 of the animal 140. The collar 130 may be fastened around the neck region 142 such that the first ring 126 is positioned towards an anterior portion 144 of a torso 146 of the animal 142.

The first clasp 120 may be positioned at the first end 106 of the leash strap 104, and may connect to the first ring 126. For example, the first clasp 120 may be a trigger snap hook enabling a user to pull the trigger to open the hook and connect the first clasp 120 to the first ring 126. The user may release the trigger to close the hook around the first ring 126. To secure the leash strap to the animal, the leash strap 104 extends from the first clasp 120 around the torso 146, wrapping underneath a first leg 150 of the animal 140. The leash strap 104 additionally extends around the back of the animal 140, and underneath a second leg 152 of the animal 142. The second clasp 122 positioned at the second end 108 of the leash strap 104 may connect to the first ring 126.

The second ring 134 may be positioned on a posterior portion of the torso 146 of the animal 140. The leash extension 132 extends from the posterior portion of the torso 146 of the animal 140. The handle 136 of the leash extension 132 is configured to be held by a user that may exert a pulling force along the length of the leash extension 132 to control and/or guide the animal. The pulling force extends to the second ring 134. The pulling force may be a reactionary force to a pulling force from the animal, for example, as the animal begins to move away from the user.

The leash system 100 may distribute the pulling force along the leash strap 104 to the first ring 126, causing a pulling force on the first ring 126 in an inferior direction to the neck region 142 of animal 140, forcing the animal's snout or head into a downwards motion. The pulling force on the first ring 126 may be in an inferior direction due to the positioning of the connection of the first clasp 120 and the second clasp 122 to the first ring 126 on the anterior portion 144 of a torso 146 of the animal 140. The resulting force at the first ring 126 is in an inferior direction due to the leash strap extending in an inferior direction from the first clasp 120 and second clasp 122. Accordingly, the inferior force on the first ring 126 pulls a head 154 and/or snout of the animal 140 in an inferior direction (i.e., a downwards motion). This avoids unwanted pulling forces in a superior direction in relation to the neck region 142 of animal 140. As described above in relation to the prior art, these pulling forces may cause choking or other injury to the animal's throat or neck region.

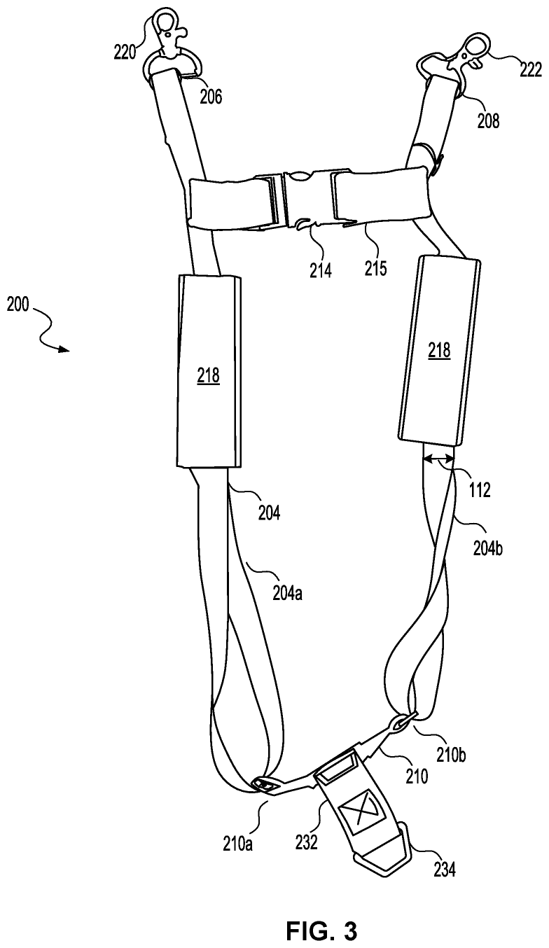

FIG. 3 illustrates an exemplary leash system 200 in accordance with embodiments of the present disclosure. Leash system 200 may include similar features to leash system 100 described above. For example, leash system 200 may include a leash strap 204 having a first end 206, a second end 208, and a middle portion 210 that extends between the first end 206 and the second end 208. The leash strap 204 may include a durable synthetic webbing that may incorporate a variety of materials including, but not limited to, polypropylene, nylon, polyester, cotton, among others. The leash strap 204 may be designed to withstand forces exerted by an animal, such as a dog or other household pet, of various sizes including small and large animals. In some embodiments, the leash strap 204 may have a width 212 and a thickness (not shown). The width 212 and the thickness of the leash strap 204 may vary depending on the size of the animal the leash strap 204 is fastened around. For example, the leash strap 204 may have a larger width 212 and a larger thickness for a larger animal to increase the strength of the leash strap 204. The leash strap 204 may also include a clip 214 positioned on a connection strap 215 that connects the first end 206 to the second end 208 when the clip 214 is connected.

Leash system 200 may also include pads 218 positioned along the length of the leash strap 204. In some embodiments, the pads 218 may be positioned closer to the first end 206 and the second end 208. The leash strap 208 may extend through each of the pads 218 such that the pads surround the leash strap 204. The pads 218 may be secured to the leash strap to maintain a consistent position on the leash strap 204, or may be moveable along the length of the leash strap 204 to adjust the position of the pads 218 to be ideally positioned based on the size or shape of the animal.

The leash strap 204 may include a first clasp 220 positioned at the first end 206 of the leash strap 204 and a second clasp 222 positioned at the second end 208 of the leash strap 204. Non-limiting examples of the first clasp 220 and second clasp 222 include, but are not limited to, trigger snap hooks, swivel snap hooks, lobster clasps, carabiner clasps, among others. The first clasp 220 and the second clasp 222 may be connected to a first ring 126 on a collar 130, as described above. In some embodiments, connection strap 215 is positioned nearer to the first clasp 220 and the second clasp 222.

The middle portion 210 of the leash system 200 may be a separate strap that connects to the leash strap 204. The middle portion 210 may be attached to a strap extension 232 that is connected to a second ring 234. A leash extension (e.g. leash extension 132 described above) may extend away from the leash strap 204 and terminate in a handle that a user may hold when handling an animal.

In some embodiments, leash strap 204 includes two separate straps 204a and 204b that are connected to each other via middle portion 210. For example, leash strap 204a may have an end 206 connected to clasp 220 and an opposing end 206a connected to a first end 210a of middle portion 210. Leash strap 204b may have an end 208 connected to clasp 222 and an opposing end 208a connected to a second end 210b of middle portion 210. The middle portion 210 may connect to strap 204a at end 210a and strap 204b at end 210b via clasps 236. Clasps 236 may include, for example, trigger snap hooks, swivel snap hooks, lobster clasps, carabiner clasps, among others. Connection strap 215 may be positioned nearer to the first clasp 220 and the second clasp 222 to connect strap 204a to strap 204b.

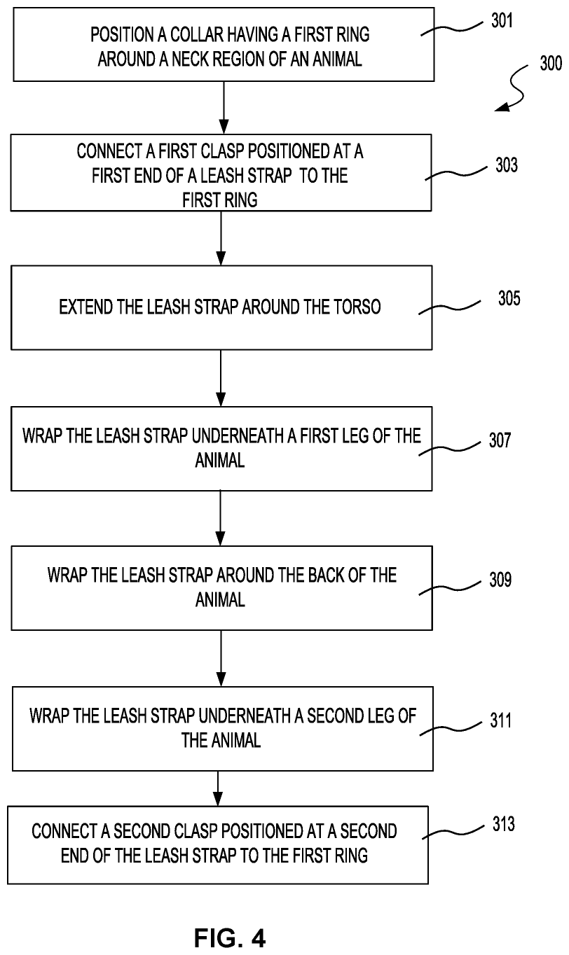

FIG. 4 illustrates an exemplary method 300 of fastening a leash system (e.g. leash system 100) to an animal (e.g. animal 140). The method 300 may include step 301 that positions a collar (e.g. collar 130) having a first ring (e.g. first ring 126) around a neck region (e.g. neck region 142) of the animal such that the first ring is positioned towards an anterior portion (e.g. anterior portion 144) of a torso (e.g. torso 146) of the animal. The method 300 may include step 303 that connects a first clasp (e.g. first clasp 120) positioned at a first end (e.g. first end 106) of a leash strap (e.g. leash strap 104) to the first ring. The method 300 may include step 305 that extends the leash strap around the torso, step 307 that wraps the leash strap underneath a first leg of the animal, step 309 that wraps the leash strap around the back of the animal, and step 311 that wraps the leash strap underneath a second leg of the animal. The method 300 may include step 313 that connects a second clasp (e.g. second clasp 122) positioned at a second end (e.g. second end 108) of the leash strap to the first ring.

In some embodiments, the method 300 may include a step for connecting a leash extension having a second ring to a middle portion of the leash strap between the first clasp and the second clasp. The method may also include a step for positioning the second ring towards a posterior portion of the torso of the animal.

The foregoing description has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware and software, but systems and methods consistent with the present disclosure can be implemented as hardware alone. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Other embodiments will be apparent from consideration of the specification and practice of the embodiments disclosed herein. It is intended that the specification and examples be considered as example only, with a true scope and spirit of the disclosed embodiments being indicated by the following claims.

What is claimed is:

1. A leash system for guiding an animal, the leash system comprising:
a collar for placement around a neck region of the animal, the collar having a first ring positioned towards an anterior portion of a torso of the animal;
a leash strap having a first end, a second end, and a middle portion, the leash strap comprising:
a first clasp positioned at the first end of the leash strap, the first clasp for connecting to the first ring; and
a second clasp positioned at the second end of the leash strap, the second clasp for connecting to the first ring, wherein the leash strap extends around the torso, wrapping underneath a first leg of the animal, around the back of the animal, and underneath a second leg of the animal; and
a leash extension having a second ring for receiving the middle portion of the leash strap between the first clasp and the second clasp.

2. The leash system of claim 1, wherein the first clasp and the second clasp each comprise trigger snap hooks.

3. The leash system of claim 1, wherein the first clasp and the second clasp each comprise lobster clasps.

4. The leash system of claim 1, wherein the second ring is positioned towards a posterior portion of the torso of the animal.

5. The leash system of claim 4, wherein the leash extension extends from the posterior portion of the torso of the animal.

6. The leash system of claim 1, wherein the leash extension is configured to enable a pulling force along the length of the leash extension to the second ring when guiding the animal.

7. The leash system of claim 6, wherein the leash strap distributes the pulling force to the first ring.

8. The leash system of claim 7, wherein the distributed pulling force on the first ring pulls a neck region of the animal in an inferior direction.

9. The leash system of claim 1, the leash strap further comprising a length-adjustment clip for adjusting a length of the leash strap.

10. The leash system of claim 9, wherein the length-adjustment clip is a snap buckle.

11. A method of fastening a leash system to an animal, the method comprising:
positioning a collar having a first ring around a neck region of the animal such that the first ring is positioned towards an anterior portion of a torso of the animal;
connecting a first clasp, positioned at a first end of a leash strap, to the first ring;
extending the leash strap around the torso;
wrapping the leash strap underneath a first leg of the animal;
wrapping the leash strap around the back of the animal;
wrapping the leash strap underneath a second leg of the animal; and
connecting a second clasp, positioned at a second end of the leash strap, to the first ring.

12. The method of claim 11, further comprising:
connecting a leash extension having a second ring to a middle portion of the leash strap between the first clasp and the second clasp.

13. The method of claim 12, further comprising:
positioning the second ring towards a posterior portion of the torso of the animal.

14. The method of claim 12, wherein the leash extension extends from the posterior portion of the torso of the animal.

15. The method of claim 12, further comprising:
pulling the leash extension to create a pulling force along the length of the leash extension to the second ring when guiding the animal, wherein the leash strap distributes the pulling force to the first ring.

16. The method of claim 15, wherein the distributed pulling force on the first ring pulls a head of the animal in an inferior direction.

17. A leash system for guiding an animal, the leash system comprising:
a leash strap having a first end, a second end, and a middle portion, the leash strap comprising:
a first clasp positioned at the first end of the leash strap, the first clasp for connecting to a first ring of a collar placed around a neck region of the animal, wherein the first ring is positioned towards an anterior portion of a torso of the animal;
a second clasp positioned at the second end of the leash strap, the second clasp for connecting to the first ring, wherein the leash strap extends around the torso, wrapping underneath a first leg of the animal, around the back of the animal, and underneath a second leg of the animal; and
a second ring positioned at the middle portion of the leash strap between the first clasp and the second clasp, the second ring configured to connect to a leash extension.
